(19) United States
(12) Patent Application Publication
(10) Pub. No.: US 2009/0053601 A1
(43) Pub. Date: Feb. 26, 2009

(54) Modular Bipolar Battery

(76) Inventor: Kurtis C. Kelley, Washington, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/887,399

(22) PCT Filed: Mar. 29, 2006
(86) PCT No.: PCT/US2006/011450

§ 371 Date: Sep. 28, 2007

Related U.S. Application Data
(60) Provisional application No. 60/666,773, filed on Mar. 31, 2005.

(51) Int. Cl. H01M 4/66; B32B 37/14; B29C 45/14; H01M 6/02

(52) U.S. Cl. 429/210; 156/308.2; 264/259; 29/623.2

(57) ABSTRACT

A bipolar electrode module for a modular bipolar battery includes an electrode substrate having a first face, a second face, and a perimeter. An electrical connection element is disposed on the electrode substrate such that the electrical connection element overlaps at least a portion of both the first face and the second face of the electrode substrate. A first carbon foam current collector is attached to the first face of the electrode substrate, and a second carbon foam current collector is attached to the second face of the electrode substrate. A frame is attached to the electrode substrate along at least a portion of the perimeter of the electrode substrate.

This application claims priority to U.S. Provisional Patent Application No. 60/666,773, filed on Mar. 31, 2005.

### TECHNICAL FIELD

This invention relates generally to a battery and, more particularly, to a modular bipolar battery including carbon foam current collectors.

### BACKGROUND

Lead acid batteries are known to include at least one positive current collector, at least one negative current collector, and an electrolytic solution including, for example, sulfuric acid (H₂SO₄) and distilled water. In traditional lead acid batteries, both the positive and negative current collectors can include grid-like plates formed of lead. These batteries can be heavy due to the presence of lead grids and the peripheral components (grid lug, electrode current strap, and intercell connections) needed to support the monopolar configuration of many lead acid batteries (i.e., each battery electrode plate functions exclusively as either a positive plate or as a negative plate). Traditional lead acid batteries may also provide fairly low specific energy and specific power values. Further, a notable limitation to the durability of lead acid batteries is anodic corrosion of the lead-based components of the positive current collector.

Bipolar batteries have been proposed in an attempt to provide improved performance over traditional lead acid batteries. A bipolar battery may include bipolar electrode plates that can function as both positive and negative electrodes within the battery. Specifically, each individual electrode plate has both a positive and a negative active face. These two faces are electrically connected and, therefore, reside at the same electrical potential. The two faces, however, are separated by a barrier that is impermeable to the electrolytic solution in the battery. Therefore, despite being physically part of a single electrode plate, the two active faces of the bipolar electrode plates reside in separate cells of the battery. As a result, the bipolar electrode plate may serve both as a negative plate in one cell and as a positive plate in an adjacent cell.

As a result of their design, bipolar batteries may provide several advantages over traditional lead acid batteries. Bipolar batteries may include assemblies of low current cells that together are capable of carrying power at high voltage levels. Thus, there may be no need for the heavy lead components of traditional lead acid batteries (e.g., lugs, straps, busses, etc.), which carry the low voltage, high current power of these batteries. As a result, bipolar batteries may be made smaller and lighter than their monopolar counterparts. Further, bipolar batteries may provide improved specific energy and specific power values over traditional lead acid batteries.

U.S. Pat. No. 4,275,130 to Rippel et al. (“the '130 patent”) describes one example of a bipolar battery. While the '130 patent may provide lead acid batteries with lower weight and higher specific energy values as compared to traditional lead acid batteries, the lifespan of the bipolar batteries of the '130 patent may still be reduced due to corrosion. The '130 patent specifically notes mat the life expectancy of at least one lead-based component in its bipolar battery is only five years due to the action of anodic corrosion.

The present invention is directed to overcoming one or more of the problems or disadvantages existing in the bipolar batteries of the prior art.

### SUMMARY OF THE INVENTION

One aspect of the present invention includes a bipolar electrode module for a modular bipolar battery. The electrode module includes an electrode substrate having a first face, a second face, and a perimeter. An electrical connection element is disposed on the electrode substrate such that the electrical connection element overlaps at least a portion of both the first face and the second face of the electrode substrate. A first carbon foam current collector is attached to the first face of the electrode substrate, and a second carbon foam current collector is attached to the second face of the electrode substrate. A frame is attached to the electrode substrate along at least a portion of the perimeter of the electrode substrate.

A second aspect of the present invention includes a method of making a bipolar electrode module. The method includes disposing an electrical connection element on an electrode substrate having a first face, a second face, and a perimeter such that the electrical connection element overlaps at least a portion of both the first face and the second. A first carbon foam current collector is attached to the first face of the electrode substrate, and a second carbon foam current collector is attached to the second face of the electrode substrate. A frame is sealably fixed to the electrode substrate along the perimeter.

A third aspect of the present invention includes a modular bipolar battery. The battery includes a positive terminal electrode module, a negative terminal electrode module, and at least one bipolar electrode module disposed between the positive and negative terminal electrode modules. The at least one bipolar electrode module includes an electrode substrate having a first face, a second face, and a perimeter. An electrical connection element overlaps at least a portion of both the first face and the second face. A first carbon foam current collector is disposed on the first face of the substrate, and a second carbon foam current collector is disposed on the second face of the substrate. A chemically active paste is disposed on both the first and second carbon foam current collectors, and a frame is attached to the electrode substrate along at least a portion of the perimeter of the electrode substrate.

### BRIEF DESCRIPTION OF THE DRAWINGS

FIG. 1 is a diagrammatic front view of a modular bipolar battery in accordance with an exemplary embodiment of the present invention.

FIG. 2A is a diagrammatic cross-sectional view of an electrode module in accordance with an exemplary embodiment of the present invention.

FIG. 2B is a diagrammatic cross-sectional view of the modular bipolar battery of FIG. 1 taken along the line 2B.

### DETAILED DESCRIPTION

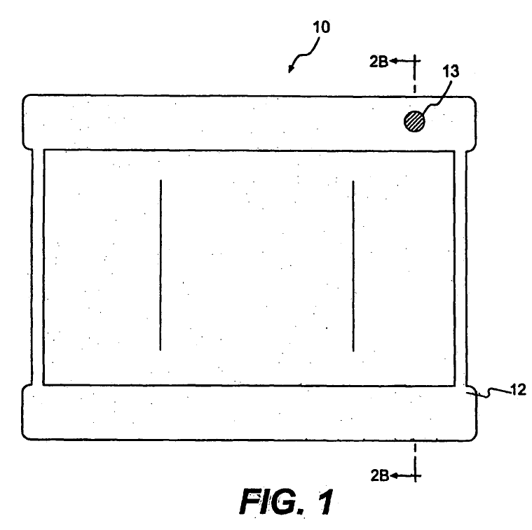

FIG. 1 illustrates a modular bipolar battery 10. Battery 10 may include a housing 12 that contains the electrical components of battery 10. Battery 10 may also include a positive terminal 13 and a negative terminal (not shown) that provide electrical connection points between electrical-components internal to battery 10 and any external load.

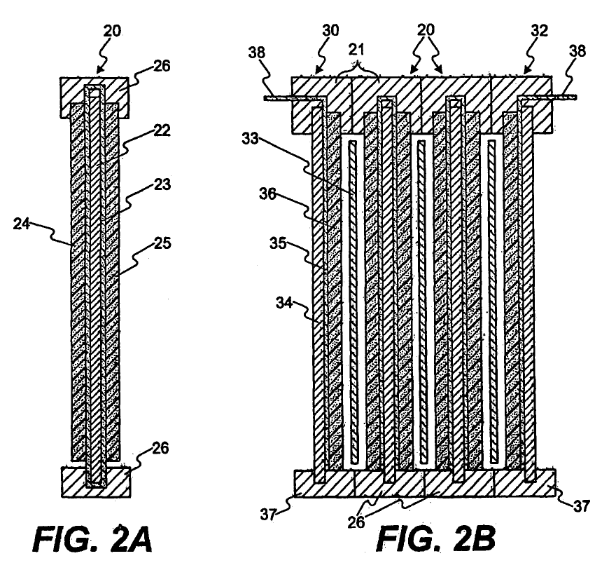

FIG. 2A provides a diagrammatic cross-sectional view of a bipolar electrode module 20 which may serve as a building block for modular bipolar battery 10. Each bipolar electrode module 20 includes a substrate 22, an electrical connection element 23, current collectors 24 and 25, and a frame 26. In bipolar electrode 20, current collectors 24 and 25 are electrically connected to one another and maintained at the same voltage potential. The electrical connection between current collectors 24 and 25 may be formed, as shown in FIG. 2, using electrical connection element 23. Alternatively, to form the electrical connection between current collectors 24 and 25, substrate 22 may include a conductive material. For example, substrate 22 may include a conductive polymer having, for example, conductive particles or fibers dispersed within a polymer matrix.

Substrate 22 may perform several functions in battery 10. For example, substrate 22 may provide rigid support for current collectors 24 and 25. Substrate 22 can also be used to chemically isolate the cells 21 (FIG. 2B) of battery 10. To function in this manner, substrate 22 may be bonded or attached to frame 26 to form a seal. Further, substrate 22 may be formed of a material mat is impermeable to the electrolyte used in battery 10. Such a configuration prevents the flow of electrolyte between adjacent cells 21 and can, therefore, enable electrode plates 20 to operate in a bipolar capacity.

Substrate 22 may be formed from a thermoplastic material that softens and/or melts upon application of a sufficient amount of heat. This property may be useful, although not necessary, for attaching and sealing substrate 22 to frame 26. Specifically, substrate 22 may be joined to frame 26 through the application of heat that can cause these two components to bond together. Alternatively, substrate 22 may be attached to frame 26 using a molding process, an adhesive, or any other suitable method for forming the seal between substrate 22 and frame 26.

For example, in the disclosed molding process, frame 26 may be molded about substrate 22 using any suitable molding process (e.g., injection molding). In such a process, substrate 22 and optionally other components of bipolar electrode module 20 (e.g., current collectors, electrical connection elements, etc.), may be sized to extend into an injection mold that may be used to form frame 26. Thus, upon injecting the frame material into the mold, the portions of components included within the mold may be encapsulated by the frame material. As a result, frame 26 may be bonded and sealed together with substrate 22 and, optionally, other components of electrode module 20.

As an additional step in attaching substrate 22 to frame 26, a thin layer of polymer (e.g., polypropylene or other suitable material) may be applied to at least a portion of current collector 24, 25 or electrical connection element 23 that may extend within the mold used to form frame 26. Such a polymer layer may protect these components during the molding process.

Substrate 22 may include a wide variety of materials. For example, substrate 22 may include polypropylene. In still other embodiments, substrate 22 may include one or more of ABS plastic (i.e., acrylonitrile butadiene styrene), polyvinylchloride, polyethylene, and any other suitable material.

Similarly, frame 26 may include a wide variety of materials. In one embodiment, frame 26 may include a thermoplastic polymer. Frame 26 may also include polypropylene, ABS plastic, polyvinylchloride, polyethylene, or any other suitable material. In certain embodiments, frame 26 may be formed from the same material used to form substrate 22.

Electrical connection element 23 may be used to establish an electrical connection between current collector 24 and current collector 25, especially in embodiments where substrate 22 is formed from an electrically nonconductive material. Electrical connection element 23 may be applied to substrate 22 such that electrical connection element 23 overlaps at least a portion of both primary faces (e.g., where current collectors 24 and 25 are attached) of substrate 22. For example, prior to attaching current collectors 24 and 25 to substrate 22, electrical connection element 23 may be draped over or wrapped around substrate 22. Applying electrical connection element 23 to substrate 22 in this manner may enhance the integrity of the electrical connection formed between electrical connection element 23 and current collectors 24 and 25.

Electrical connection element 23 may be formed from any suitable conductive material. In one exemplary embodiment of the invention, electrical connection element 23 may include one or more carbon fibers. In other embodiments, electrical connection element 23 may include at least one of boron, graphite, carbon, a conductive polymer, and metals. Further, electrical connection element 23 may include at least one of carbon fiber cloth, carbon fiber tape, unwoven carbon fiber cloth, a single carbon fiber, a plurality of carbon fibers, a bundle of carbon fibers, graphite fiber cloth, graphite fiber tape, unwoven graphite fiber cloth, a single graphite fiber, a plurality of graphite fibers, and a bundle of graphite fibers.

Each bipolar electrode module 20 includes current collectors 24 and 25 disposed on opposing faces of substrate 22. Each current collector 24, 25 may be formed from a porous carbon material such as, for example, carbon foam. The carbon foam of an exemplary embodiment of the invention may have an average pore size of between about 40:m and about 2.0 mm, and a total porosity value for the carbon foam may be at least 60%. In other words, at least 60% of the volume of the carbon foam structure may be included within pore structures. Moreover, the carbon foam may have an open porosity value of at least 90%. Therefore, at least 90% of pore structures included in current collectors 24, 25 are open to adjacent pores such that the pore structures of the carbon foam form a substantially open network. This open network, in combination with the average pore size, allows chemically active paste deposited on each current collector 24, 25 to penetrate within the carbon foam structure. In certain forms, the carbon foam may offer sheet resistivity values of less than about 1 ohm/cm. In still other forms, the carbon foam may have sheet resistivity values of less than about 0.75 ohm/cm.

The disclosed foam material may include any carbon-based material having a reticulated pattern including a three-dimensional network of struts and pores. The foam may comprise either or both of naturally occurring and artificially derived materials.

Graphite foam may also be used to form current collectors 24, 25. One such graphite foam, under the trade name PocoFoam™, is available from Poco Graphite, Inc. The density and pore structure of graphite foam may be similar to carbon foam. A primary difference between graphite foam and carbon foam is the orientation of the carbon atoms in the graphite foam. For example, in carbon foam, the carbon may be primarily amorphous. In graphite foam, however, much of the carbon is ordered into a graphite, layered structure. Because of the ordered nature of the graphite structure, graphite foam can offer higher conductivity than carbon foam. PocoFoam™ graphite foam exhibits electrical resistivity values of between about 100:Σ/cm and about 400:Σ/cm.

Substrate 22, electrical connection element 23, and current collectors 24, 25 may be assembled together using heat and/or pressure. For example, electrical connection element 23 may be disposed on substrate 22, as described above, and sandwiched between two layers of carbon foam, or other type of porous carbon material, to form a stacked structure. Heat may be applied to the stacked structure to soften and/or slightly melt substrate 22. Softening and/or melting of substrate 22 may encourage permeation of at least a portion of the material of substrate 22 into the pores of the carbon foam. In addition to heat, pressure may also be applied to the stacked structure. The application of external pressure may aid in forcing the softened substrate 22 into the pores of the carbon foam. In one exemplary embodiment, heat and pressure may be applied simultaneously. In certain situations, however, heat may be applied exclusive of pressure, hi still other situations, the application of heat may occur separate from the application of pressure.

Alternatively, electrical connection element 23 and carbon foam current collectors 24, 25 may be bonded to substrate 22 using an adhesive. For example, a layer of epoxy or other suitable adhesive may be spread over the opposing faces of substrate 22 and electrical connection element 23. Carbon foam current collectors 24, 25 may then be placed onto substrate 22. The adhesive may permeate the pores of the carbon foam and bond current collectors 24, 25 to substrate 22 without applying heat or pressure. The application of heat and/or pressure may, however, facilitate permeation of the adhesive material into the pores of the carbon foam.

Prior to incorporating bipolar electrode modules into battery 10, a chemically active paste may be applied to current collectors 24, 25. The chemically active paste that is applied to each of current collectors 24, 25 may be substantially the same in terms of chemical composition. For example, the paste may include lead oxide (PbO). Other oxides of lead may also be suitable. The paste may also include various additives including, for example, varying percentages of free lead, structural fibers, conductive materials, carbon, and extenders to accommodate volume changes over the life of the battery. The constituents of the chemically active paste may be mixed with a small amount of sulfuric acid and water to encourage permeation of the paste into pores of the carbon foam.

In the disclosed modular bipolar battery, no processing or curing of the chemical active paste on current collectors 24, 25 is required. Optionally, however, the chemically active paste may be allowed to dry on current collectors 24, 25.

FIG. 2B provides a diagrammatic cross-sectional view of modular bipolar battery 10 taken along line 2B, as shown in FIG. 1. Battery 10 includes a positive terminal electrode module 30, a negative terminal module 32, at least one electrical separator 33, and any desired number of bipolar electrode modules 20.

Both positive terminal electrode module 30 and negative terminal electrode module 32 are of similar construction and can include a substrate 34, a terminal connector 35, and a current collector 36. As in the construction of bipolar electrode modules 20, substrate 34 of positive terminal electrode module 30, for example, may be attached to a frame 37. In one embodiment of the invention, substrate 34 is sealed to frame 37 and serves as ah outer wall of battery 10. Substrate 34, current collector 36, and frame 37 may be made of similar materials as those described above with respect to substrate 22, current collectors 24, 25, and frame 26, respectively. Further, a chemically active paste may be included on current collector 36.

Terminal connector 35 may establish an electrical conduction path between current collector 36 and electrical elements external to battery 10 (e.g., any type of element that may draw charge from or supply charge to battery 10). While terminal connector 35 may be connected to current collector 36 in any suitable manner, in one embodiment, terminal connector 35 may be disposed between substrate 34 and current collector 36. Terminal connector 35 may be formed from any suitable conductive material including, for example, the same materials described above with respect to electrical connection element 23.

To facilitate the formation of an electrical conduction path with units external to battery 10, at least a portion of terminal connector 35 may extend through frame 37 and outside of battery 10 to establish a contact 38. Contact 38 may itself serve as a terminal of battery 10. Alternatively, a conductive terminal material, including, for example, lead or other metal, may be attached to contact 38 to form a terminal of battery 10.

An electrical separator 33 is disposed within each cell 21 of battery 10. Cells 21 are formed between adjacent pairs of electrode modules. Electrical separators 33 exhibit two primary characteristics. First they are formed of electrically insulating materials to prevent the positive current collector of one cell from shorting with the negative current collector of the same cell. Electrical separators 33 are also permeable to the electrolyte used in battery 10. This permeability enables ionic transport between the positive and negative current collectors within each 21. Electrical separators 33 may include a wide range of materials in many different configurations. For example, electrical separators 33 may include porous polymer materials, mats of glass fibers, porous aluminum nitride sheets and/or fibers, or any other suitable materials.

Battery 10 may include any number of bipolar electrode modules 20 aligned with respect to one another between positive terminal electrode module 30 and negative terminal electrode module 32. The frames of each electrode module in battery 10 may be attached together to form housing 12 (FIG. 1). Specifically, each frame may be seal ably fixed to an adjacent frame such that housing 12 can minimize or prevent substantially all fluid communication between the environments inside and outside of battery 10. The frames may be attached to one another by a variety of suitable methods including, for example, using heat and/or pressure, adhesive, friction welding, and any combination thereof. Additionally, the width of the frames may be designed such that any desired level of compression may be placed on electrical separators 33 upon attaching the frames together.

Each cell 21 of battery 10 has a voltage potential determined by the particular battery chemistry used (e.g., about 2 volts for a lead acid battery). In its most basic configuration, battery 10 may include only a single cell 21 formed between positive terminal electrode module 30 and negative terminal electrode module 32. Bach electrode module 20 that is added, however, also adds a cell to battery 10. The modular nature of electrode modules 20 allows battery 10 to be constructed using any number of electrode modules 20. As a result, any desired total voltage level for battery 10 (i.e., integer multiple of the cell voltage) may be achieved simply by assembling together the appropriate number of electrode modules 20 between positive terminal electrode module 30 and negative terminal electrode module 32.

Assembly of bipolar battery 10 creates sealed cells 21 that are substantially and/or completely fluidly isolated from other cells 21 by substrates 22, for example. The electrolyte for each cell 21 may be disposed in each cell in several ways. For example, in one exemplary embodiment, a plurality of access ports (not shown) may be formed through each frame 26, 37 such that the electrolyte may be flowed, injected, or otherwise disposed into each cell 21. After disposing electrolyte within each cell, the access ports may be sealed with a valve, a removable plug, a permanently installed plug, or any other suitable sealing device and/or process. The electrolyte may include an acid such as sulfuric acid (H₂SO₄), for example, and distilled water. Other electrolytes, however, may also be suitable.

After providing cells 21 with electrolyte, battery 10 may be subjected to a charging (i.e., formation) process. During this charging process, the chemically active paste on the current collector of positive terminal electrode module 30 and on the positive active faces of bipolar electrode modules 20 is electrically driven to lead dioxide (PbO₂). Conversely, the chemically active paste on the current collector of negative terminal module 32 and on the negative active faces of bipolar electrode modules 20 may be converted to sponge lead.

### INDUSTRIAL APPLICABILITY

The disclosed bipolar battery may be useful in any of a wide variety of applications where there is a need for low cost, lightweight, small, and/or durable energy storage devices. For example, such batteries may be used as power sources in automobiles (including hybrid and electric vehicles), heavy equipment, standby power facilities, personal electronics, and many other applications. The disclosed batteries may offer large specific energy values and significant resistance to corrosion.

Further, the modular nature of the disclosed bipolar battery may offer several advantages. For example, as mentioned above, a battery having any desired total voltage may be constructed. The modularity of the electrodes used in the battery ensures that minimal or no tooling changes would be necessary for constructing batteries with varying numbers of electrodes/cells. Further, the frames of the electrode modules may simplify fabrication procedures by providing a suitable means for handling the electrodes during battery construction.

The disclosed batteries may also be resistant to corrosion and, therefore, may offer long service lives. In general, carbon oxidizes only at very high temperatures and will resist corrosion even in highly corrosive environments. Because positive terminal electrode module 30, negative terminal electrode module 32, and bipolar electrode modules 20 may include carbon foam current collectors, these electrodes may resist corrosion even when exposed to highly corrosive environments. For example, these electrodes may resist corrosion even when exposed to sulfuric acid and to the anodic potentials in a lead acid battery. As a result, bipolar battery 10 may offer a significantly longer service life as compared to batteries without carbon foam current collectors.

Additionally, the porous nature of the carbon foam included in positive terminal electrode module 30, negative terminal electrode module 32, and bipolar electrode modules 20 may translate into batteries having high specific energy values. Specifically, the large amount of surface area provided by the carbon foam (e.g., more than 2000 times the amount of surface area provided by conventional lead current collectors) enables intimate integration of the chemically active paste with the current collectors of positive terminal electrode module 30, negative terminal electrode module 32, and bipolar electrode modules 20. Therefore, electrons produced in the chemically active paste at a particular reaction site may travel only a short distance through the paste before encountering the conductive carbon foam of an electrode current collector. This may result in improved specific energy values for bipolar battery 10. In other words, bipolar battery 10, when placed under a load, may sustain its voltage above a predetermined threshold value for a longer time than bipolar batteries including traditional lead materials.

It will be apparent to those skilled in the art that various modifications and variations can be made in the disclosed bipolar battery without departing from the scope of the disclosure. Additionally, other embodiments of the bipolar battery will be apparent to those skilled in the art from consideration of the specification. It is intended that the specification and examples be considered as exemplary only, with a true scope of the disclosure being indicated by the following claims and their equivalents.

What is claimed is:

1. A bipolar electrode module for a modular bipolar battery, the electrode module comprising:
an electrode substrate having a first face, a second face, and a perimeter;
an electrical connection element disposed on the electrode substrate such that the electrical connection element overlaps at least a portion of both the first face and the second face of the electrode substrate;
a first carbon foam current collector attached to the first face of the electrode substrate;
a second carbon foam current collector attached to the second face of the electrode substrate; and
a frame attached to the electrode substrate along at least a portion of the perimeter of the electrode substrate.

2. The bipolar electrode module of claim 1, wherein both the first carbon foam current collector and the second carbon foam current collector electrically contact the electrical connection element.

3. The bipolar electrode module of claim 1, wherein the electrode substrate and the frame comprise a thermoplastic material.

4. The bipolar electrode module of claim 1, wherein the electrode substrate and me frame are polypropylene.

5. The bipolar electrode module of claim 1, wherein the electrical connection element includes one or more carbon fibers.

6. The bipolar electrode module of claim 1, wherein the first and second carbon foam current collectors include graphite foam.

7. The bipolar electrode module of claim 1, wherein the first and second carbon foam current collectors have a total porosity value of at least 60%.

8. The bipolar electrode module of claim 1, wherein the first and second carbon foam current collectors have an open porosity value of at least 90%.

9. The bipolar electrode module of claim 1, wherein the first and second carbon foam current collectors have an average pore size of between about 40 microns and about 2.0 millimeters.

10. The bipolar electrode module of claim 1, wherein the frame is sealably fixed to the perimeter of the electrode substrate.

11. A method of making a bipolar electrode module, comprising:
disposing an electrical connection element on an electrode substrate having a first face, a second face, and a perimeter such that the electrical connection element overlaps at least a portion of both the first face and the second;
attaching a first carbon foam current-collector to the first face of the electrode substrate;
attaching a second carbon foam current collector to the second face of the electrode substrate; and
sealably fixing a frame to the electrode substrate along the perimeter.

12. The method of claim 11, wherein attaching the first carbon foam current collector and attaching the second carbon foam current collector include applying heat and pressure.

13. The method of claim 11, wherein sealably fixing a frame to the electrode substrate includes injection molding the frame.

14. A modular bipolar battery, comprising:
a positive terminal electrode module;
a negative terminal electrode module; and
at least one bipolar electrode module disposed between the positive and negative terminal electrode modules, wherein the at least one bipolar electrode module includes:
an electrode substrate having a first face, a second face, and a perimeter;
an electrical connection element overlapping at least a portion of both the first face and the second face;
a first carbon foam current collector disposed on the first face of the substrate;
a second carbon foam current collector disposed on the second face of the substrate;
a chemically active paste disposed on both the first and second carbon foam current collectors; and
a frame attached to the electrode substrate along at least a portion of the perimeter of the electrode substrate.

15. The modular bipolar battery of claim 14, wherein the frame of the at least one bipolar electrode module is sealably fixed to the electrode substrate.

16. The modular bipolar battery of claim 14, further comprising a plurality of electrical separators interleaved with the positive terminal electrode module, the at least one bipolar electrode module, and the negative terminal electrode module.

17. The modular bipolar battery of claim 16, wherein the plurality of electrical separators comprise aluminum nitride.

18. The modular bipolar battery of claim 14, further comprising an electrolyte disposed between the positive terminal electrode module, the at least one bipolar electrode module, and the negative terminal electrode module.

19. The modular bipolar battery of claim 14, wherein both the positive terminal electrode module and the negative terminal electrode module include:
a terminal frame;
a substrate sealably fixed to the terminal frame;
a carbon foam current collector disposed on the substrate; and
an electrical connection element in electrical contact with the carbon foam current collector.

20. The modular bipolar battery of claim 19, wherein the electrical connection element of the positive terminal electrode module extends through the terminal frame of the positive terminal electrode module, and the electrical connection element of the negative terminal electrode module extends through the terminal frame of the negative terminal electrode module.

21. The modular bipolar battery of claim 19, wherein the substrate of the positive terminal electrode module forms a first wall of the battery, and the substrate of the negative terminal electrode module forms a second wall of the battery.

22. A method of making a modular bipolar battery, the method comprising:
aligning a plurality of electrode modules each including:
an electrode substrate attached to a frame;
at least one carbon foam current collector disposed on the electrode substrate; and
a chemically active paste disposed on the carbon foam current collector;
interleaving a plurality of electrical separators with the plurality of electrode modules;
sealably fixing together the frames of adjacent electrode modules; and
disposing an electrolyte between adjacent electrode modules.

23. The method of claim 22, wherein the plurality of electrode modules includes:
a positive terminal electrode module;
a negative terminal electrode module; and
at least one bipolar electrode module disposed between the positive terminal electrode module and the negative terminal electrode module.

24. The method of claim 22, further comprising charging the modular bipolar battery.

25. The method of claim 22, wherein sealably fixing together the frames of adjacent electrode modules includes attaching the frames by at least one of applying heat, applying pressure, applying adhesive, and friction welding.

26. A modular bipolar battery, comprising:
a positive terminal electrode module including a frame, a carbon foam current collector disposed on a substrate, the substrate being sealably fixed to the frame, and a positive terminal electrical connection element extending through the frame and making electrical contact with the carbon foam current collector of the positive terminal electrode module;
a negative terminal electrode module including a frame, a carbon foam current collector disposed on a substrate, the substrate being sealably fixed to the frame, and a negative terminal electrical connection element extending through the frame and making electrical contact with the carbon foam current collector of the negative terminal electrode module;
at least one bipolar electrode module disposed between the positive terminal electrode module and the negative terminal electrode module, wherein the at least one bipolar electrode module includes:
an electrode substrate having a first face, a second face, and a perimeter;
an electrical connection element overlapping at least a portion of both the first face and the second face;
a first carbon foam current collector disposed on the first face of the electrode substrate;
a second carbon foam current collector disposed on the second face of the electrode substrate;
a chemically active paste disposed on both the first and second carbon foam current collectors; and
a frame sealably attached to the electrode substrate along the perimeter;
a plurality of electrical separators interleaved with the at least one bipolar electrode module, the positive terminal electrode module, and the negative terminal electrode module; and
an electrolyte disposed between the at least one bipolar electrode module, the positive terminal electrode module, and the negative terminal electrode module.
